(19) United States
(12) Patent Application Publication
(10) Pub. No.: US 2008/0244268 A1
(43) Pub. Date: Oct. 2, 2008

(54) End-to-end network security with traffic visibility

(76) Inventors: David Durham, Beaverton, OR (US); Men Long, Hillsboro, OR (US); Prashant Dewan, Hillsboro, OR (US); Karanvir Grewal, Hillsboro, OR (US)

Correspondence Address: TROP PRUNER & HU, PC, 1616 S. VOSS ROAD, SUITE 750, HOUSTON, TX, 77057-2631, US

(21) Appl. No.: 11/731,562

(22) Filed: Mar. 30, 2007

(51) Int. Cl. H04L 9/00

(52) U.S. Cl. 713/171; 713/155

(57) ABSTRACT

Both end-to-end security and traffic visibility may be achieved by a system using a controller that derives a cryptographic key that is different for each client based on a derivation key and a client identifier that is conveyed in each data packet. The controller distributes the derivation key to information technology monitoring devices and a server to provide traffic visibility. The key may be derived using a cryptographic one way function and a client identifier so that end-to-end security may be achieved.

### BACKGROUND

This relates generally to maintaining the security of networks against intruders.

Many network security protocols depend on negotiating session keys between clients and servers using expensive asymmetric cryptography and then requiring servers to keep track of a large number of symmetric keys negotiated for each client session. End-to-end security means that there is data authenticity and/or confidentiality of data from one side of a communication in the network all the way to the side, e.g., client-to-server and server-to-client. Traffic visibility means that servers and information technology (IT) monitoring devices can view the secured traffic. To some degree, these two goals oppose one another, but both are important for network security.

End-to-end security is important for both clients and servers in order to exclude third parties from tampering with traffic between the client and server, where the client is the most exposed to direct manipulation or tampering. Thus, the uniqueness of the client's secrets is paramount to prevent the compromise of one client from gaining access to the traffic of other clients. Traffic visibility is vital to the IT administration and requires the IT administration to observe traffic to detect abnormal phenomenon. Many current major security protocols only provide end-to-end security without concern for traffic visibility.

### BRIEF DESCRIPTION OF THE DRAWINGS

FIG. 1 is an enterprise network security diagram in accordance with one embodiment of the present invention;

FIG. 2 is a depiction of a sequence on a client platform in accordance with one embodiment;

FIG. 3 is another client platform sequence in accordance with one embodiment;

FIG. 4 is a server sequence in accordance with one embodiment;

FIG. 5 is another sequence in accordance with one embodiment; and

FIG. 6 is a hardware depiction in accordance with one embodiment.

### DETAILED DESCRIPTION

Embodiments of the present invention provide a security protocol that enables both end-to-end security and traffic visibility by authorized IT devices. Hardware-based, wire speed end-to-end encryption and authentication is achieved on a frame-by-frame basis using a derived key mechanism. Clients and server communicate with a domain controller that grants derived keys and their associated derivation information to authenticated clients and derivation keys to authenticated servers. Upon receiving a frame from a particular client, server hardware extracts the key derivation information from the frame, applies the derivation key to this information, and thus, derives the cryptographic key used for the frame without having to lookup or negotiate a session key. The derived key granted to one client will not be known to, and cannot be computed by, any other client. Only servers can derive the associated client keys. To solve the traffic visibility issue, the domain controller may also send the derivation key to authorized IT network appliances, such as, for example, an IT monitoring device/host. With the authorized IT network appliances having the same derivation key mechanism as the servers, the authorized IT network appliances are able to decrypt the encrypted pass-thru traffic at full wire speed, thus, enabling traffic visibility by the authorized IT network appliances.

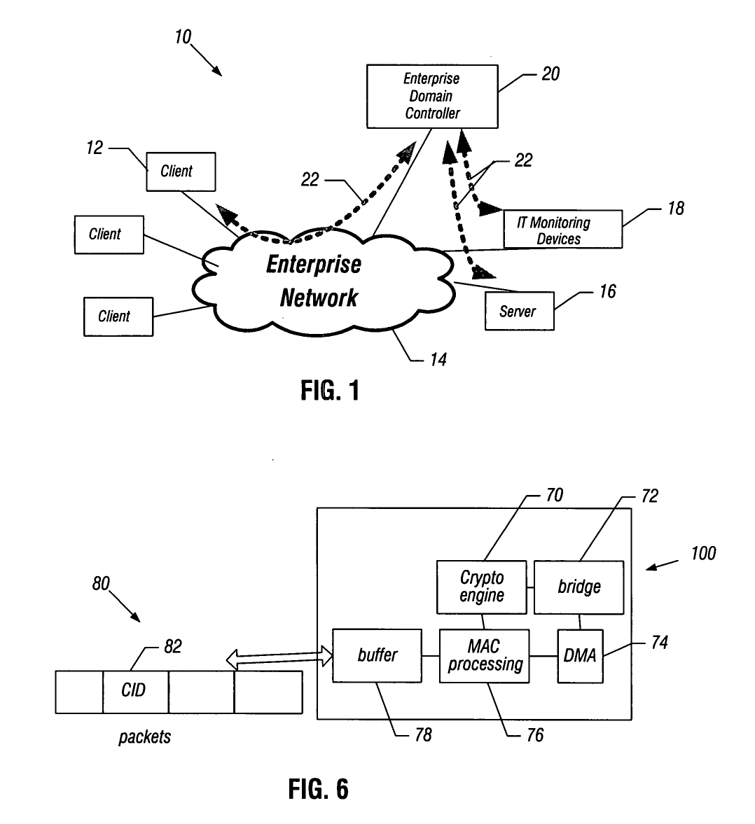

Referring to FIG. 1, an enterprise network 14 may be leveraged to communicate a plurality of clients 12 with one or more servers 16. An enterprise domain controller 20 is responsible for maintaining both end-to-end security for the entire enterprise and for maintaining traffic visibility for the server 16 and the IT monitoring devices 18. The domain controller 20 may be, for example, an authentication, authorization, and auditing (AAA) server, a key distribution server, or a policy server, to mention a few examples.

The enterprise domain controller 20 distributes derived keys (as indicated by arrows 22) to clients 12 and sends their derivation keys to server 16 and IT network monitoring host 18. The client key or the derived key is derived from a cryptographic one way function on derivation key and the identifier of the client. The derivation can be expressed as: client_key←f(derivation_key,client_ID), where f is a cryptographic one way function and client_ID is the identifier of clients, such as the client's Internet Protocol address or other designated identifier by the enterprise domain controller 20 or a combination of different attributes in the packet. This unique client_ID is communicated with each secure packet and is used as the secure session identifier. Therefore, each client 12 has different and independent keys and identifiers.

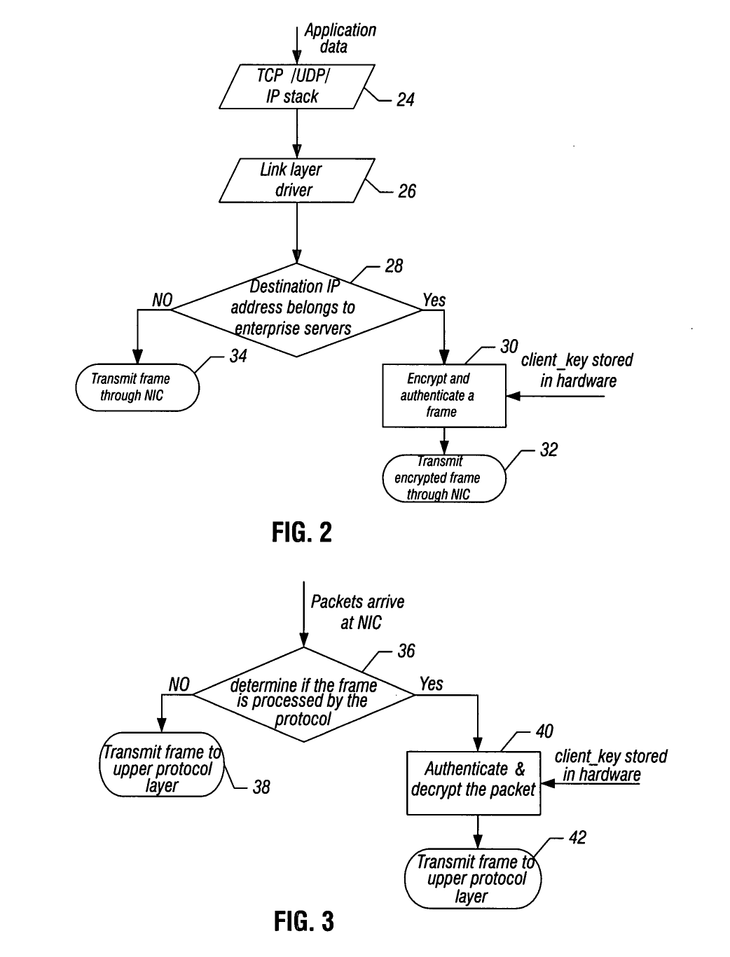

Referring to FIG. 2, a sequence of storing and applying one or more client keys distributed by the domain controller 20 is depicted. All of the outgoing frames to an enterprise server are encrypted and authenticated by the client key. Initially, application data comes into a Transmission Control Protocol (TCP)/User Datagram Protocol (UDP)/Internet Protocol (IP) stack as indicated at 24. The Internet Protocol packets are distributed to a server by the stack. Then the link layer driver forms the layer-2 frame, as indicated at 26. A check at diamond 28 determines whether the destination Internet Protocol address belongs to enterprise servers. If not, the frame is transmitted through a network interface card as indicated at 34. If so, the frame is encrypted and authenticated, as indicated at 30, using the appropriate client_key stored in hardware. Then the encrypted frame is transmitted through the network interface card as indicated at 32.

When a client platform receives a frame, indicated as packets arrive at network interface card, a check at diamond 36, in FIG. 3, determines if the frame is processed by the protocol described herein. If not, the frame is transmitted to an upper protocol layer, as indicated at 38, and, if so, the packet is authenticated and the packet is decrypted using the appropriate client_key stored in hardware as indicated at block 40. The selection of the correct key can be done via leveraging the session ID and/or some other unique identifier or address within the packet. The frame is then transmitted to the upper protocol layer as indicated at 42.

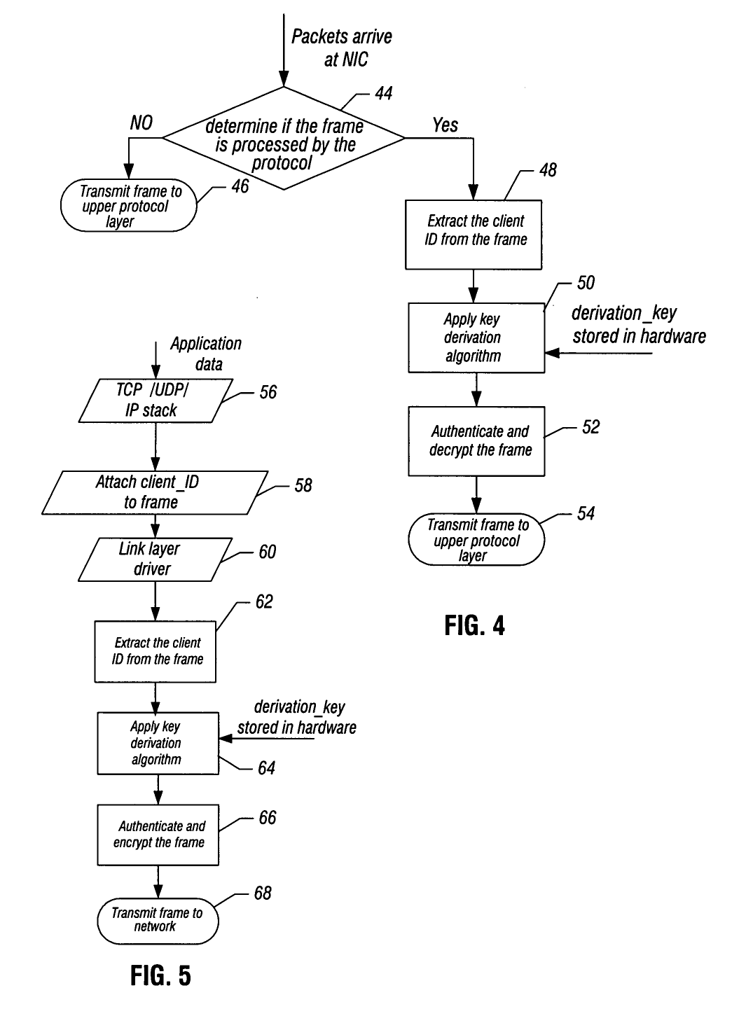

Next, referring to FIG. 4, when the server 16 receives a frame, indicated as packets arriving in a network interface card, a check at diamond 44 determines if the frame is processed by the protocol described herein. If not, the frame is transmitted to the upper protocol layer as indicated at 46. If so, the client identifier is extracted from the frame and may be used to select the appropriate derivation key, if more than one derivation key exists. The derivation key, together with the client identifier is applied to a derivation algorithm as indicated in block 50 in order to compute the session key. Then the frame is authenticated and decrypted at block 52 by using the computed session key. Finally, the frame is transmitted to an upper protocol layer at 54. The client identifier is the identifier for secure association for the given session.

The server may transmit a frame using the sequence shown in FIG. 5. Application data is received in the Internet Protocol stack at 56. The packets are distributed to various clients and a client_ID is attached to each frame in 58. A link layer driver then receives a frame at 60. At block 62, the client identifier is extracted from the frame. The client_ID is applied to a derivation algorithm at block 64 using a derivation_key stored in hardware to compute the client_key. Then the frame is authenticated and encrypted at block 66 using the computed client_key. Finally, at 68, the frame is transmitted to the network.

The IT network monitoring devices 18 (FIG. 1) operate similarly to the server 12. The server 12 and the monitoring host 18 only need to maintain a few keys to handle many different security associations from clients. An adversary compromising one client host is not able to impersonate another client because the keys for distinct clients/sessions are different and independent. For the domain controller 20, the server 16, and monitoring devices 18, since the number of keys is relatively small, the keys can be stored in hardware, while still providing proper protection for tamper resistance.

In one embodiment, a frame format may piggyback the Internet Protocol security (IPSEC) frames. A client_ID is piggybacked on the security parameter index (SPI) field of an IPSEC header. A sequence number may also be piggybacked in the IPSEC header. Otherwise, the frame may be the same as a standard IPSEC frame.

The client_ID may be assigned by the domain controller and is independent from medium access control (MAC) or IP addresses, or all or part of the client_ID may also be provided by the client. For instance, the client_ID can contain the host and user information, which can be mapped to an associated access control policy. Therefore, the client_ID enables the IT administrator to better know where a packet originated.

In embodiments, both end-to-end security and traffic visibility for an enterprise network are provided. The mechanism may be implemented entirely in hardware, in some embodiments, which achieves full wire speed performance at lower cost in some cases.

In another embodiment, the generation of the client ID and the client key may be directly or indirectly bound to a prior evaluation of the device for conformance with a given administrative policy called a role. This evaluation may take various forms and in general speaks to a known configuration/state of the device. This allows the recipient of the data to make fine grained network access control decisions based on the last known/current state of the device. For example, the client identifier may be linked to a security level that defines the client's role and indicates what the client is authorized to access. The client identifier is linked to the client's role so that once the key and identifier are bound, additional access control and security functions are possible.

Referring to FIG. 6, the hardware solution 100 includes a cryptographic engine 70 coupled to a bridge 72. The bridge 72 is coupled to a direct memory access module 74, which, in turn, is coupled to a MAC processing unit 76. The processing unit 76 communicates with incoming and outgoing packets 80 through a buffer 78. The packets 80 may include the client_ID (CID) 82. Using the derived key approach eliminates the need for on-chip random access memory for session key storage.

In one embodiment, the hardware solution 100 may be part of a network interface card or part of an integrated MAC within a processor/chipset. As such, the burden of end-to-end security may be removed from the server 16, increasing the possible scale of the network 14 in some embodiments. This allows a seamless employment of the solution, without affecting higher layer protocols/applications, in some cases.

An embodiment may be implemented by hardware, software, firmware, microcode, or any combination thereof. When implemented in software, firmware, or microcode, the elements of an embodiment are the program code or code segments to perform the necessary tasks. The code may be the actual code that carries out the operations, or code that emulates or simulates the operations. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor/machine readable/accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The term “data” here refers to any type of information that is encoded for machine-readable purposes. Therefore, it may include program, code, data, file, etc.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer-readable medium storing instructions: that, when executed, enable a computer to:
provide network security between clients and a server using a domain controller to derive one or more cryptographic session keys for each client using a cryptographic one way function that includes a client identifier; and
enable the domain controller to distribute the client session keys to a client, while delivering a derivation key to at least one of an information technology monitoring device and the server.

2. The medium of claim 1 further storing instructions to extract key derivation information from a frame received from a client.

3. The medium of claim 2 further storing instructions to derive a cryptographic session key from said information in the derivation key.

4. The medium of claim 3 further storing instructions to use receipt of the client identifier of a given session key to control network access.

5. The medium of claim 3 further storing instructions to derive a different cryptographic session key for each client using a client identifier unique to each client.

6. The medium of claim 5 further storing instructions to send said derivation key to the information technology monitoring device to enable the device to decrypt encrypted traffic to provide traffic visibility while maintaining end-to-end security.

7. The medium of claim 1 further storing instructions to bind the client identifier to a security measurement for network access control.

8. A system comprising:
a cryptographic engine to derive a cryptographic key for each of a plurality of clients using a cryptographic one way function and a client identifier; and
a MAC processing unit coupled to said cryptographic engine.

9. The system of claim 8, said engine to extract key derivation information from a frame received from a client.

10. The system of claim 9, said engine to derive the cryptographic session key from information in a derivation key.

11. The system of claim 8 to use receipt of a client identifier to control access to a network resource.

12. The system of claim 11 to employ a session key to control access to a network resource.

13. The system of claim 8, including a domain controller to send said derivation key to the information technology monitoring device to enable the device to decrypt encrypted traffic to provide traffic visibility while maintaining end-to-end security.

14. The system of claim 8 wherein said system is part of a network interface card.

15. The system of claim 8 to bind the client identifier and the key to use the identifier to indicate at least one of the client's role or privilege level within a domain.
